(19) United States
(12) Patent Application Publication
(10) Pub. No.: US 2005/0226601 A1
(43) Pub. Date: Oct. 13, 2005

(54) Device, system and method for synchronizing an effect to a media presentation

(76) Inventors: Alon Cohen, Tenafly, NJ (US); Rafi Maslaton, Tenafly, NJ (US)

Correspondence Address: PEARL COHEN ZEDEK, LLP, 10 ROCKEFELLER PLAZA, SUITE 1001, NEW YORK, NY, 10020, US

(21) Appl. No.: 11/095,590

(22) Filed: Apr. 1, 2005

Related U.S. Application Data
(60) Provisional application No. 60/560,244, filed on Apr. 8, 2004.

(51) Int. Cl. H04N 5/91

(52) U.S. Cl. 386/75

(57) ABSTRACT

A method and device for generating the list of effects and associated activation time points of media presentation and a list of synchronization time stamps or time points and values calculated from the signal, synchronizing an effect to a media playback including calculating a value from the signal, associating the calculated value with a time stamp of the media, and associating an effect signal for an effect to be generated at a time point on a time base synchronized to said time stamps. The method or system may include calculating a value from a segment or multiple segment of a signal, searching a database for such calculated value, returning a time stamp in a media presentation that is associated with such value, and returning a control signal for a physical effect that is associated with such time point of such presentation.

### CROSS REFERENCE TO RELATED APPLICATION

This application claims priority from U.S. Provisional Patent Application No. 60/560,244, filed Apr. 8, 2003, entitled “Device, System and Method for Enhancement of Video Content”, which is incorporated in its entirety herein by reference.

### BACKGROUND OF THE INVENTION

A presentation of recorded movies or a recorded audio may be enhanced by adding special effects to the recording or on a separate media, and reproducing the effects in a presentation of the recording. The synchronization of the effect with an event in the presentation may be beneficial to the impact of the effect on a listener or viewer. Improper synchronization of the effect with the sound or sight in a media presentation may impair the impact of the effect on a viewer or listener.

### SUMMARY OF THE INVENTION

Embodiments of the invention include a method for calculating a value from a digital signal in a data stream, associating the value with a time period of the data stream and associating an effect with the time period. In some embodiments the value may be calculated using for example a cyclic redundancy check algorithm applied to a for example non consecutive very low bandwidth portion of data extracted from the presentation signal such as for example data in a close caption line of a video signal. In some embodiments, the effect may be a physical effect generated to reflect an event or occurrence being presented in the data stream at the time period. In some embodiments the effect may be selected from a menu of effects, such as physical effects, and the effect may be generated prior to the event reflected in the data stream.

In some embodiments the time period may be referenced from a fixed point in the data stream. The effect timing may be triggered between events (e.g., the occurrence of closed captioning signals) where the time period is interpolated between the events and extrapolated after the events; from extrapolation, for example, a running clock or timer may be generated. In some embodiments the effect may be generated prior to the effect specified timing or the desired perception moment of the effect, to compensate for human perception response time, effect generation delay, control system delays, and effect propagation delays in different environments for example viewing room size. For example when the effect is scent or smell it may take longer for the scent to propagate from the scent generator to the viewer (e.g. smeller). In some embodiments the delay may be adjusted by the effects rendering unit from the effect's original associated timing, to enable the use of a single effects track for multiple rendering setups, different control technologies, different room sizes or user preferences where an installation may incorporate its own unique required delay that may be derived from various influencing elements.

Embodiments of the invention include calculating a value from a signal in a data stream, searching for the value in a table or collection of values, returning a first time stamp or a time point that is associated with the value as found from among such table or collection of values, and returning an effect signal associated with a second time point in the presentation where said first and second time points may be different

Embodiments of the invention include a device having a digital memory for storing one or more values calculated from signals in a data stream, where one or more of such values are associated with a time interval of such data stream. The digital memory may also store effect signals, where at least one of such effect signals is associated with a time point of such data stream.

### BRIEF DESCRIPTION OF THE DRAWINGS

Embodiments of the invention may be understood and appreciated more fully from the following detailed description taken in conjunction with the drawings in which:

FIG. 1 is a schematic diagram of components of a system for synchronizing effects with a media presentation in accordance with an exemplary embodiment of the invention;

FIG. 2 is a schematic diagram of a media storage device and a media recording unit with a data storage unit in accordance with an exemplary embodiment of the invention;

FIG. 3 is a flow chart of a method of inserting effect signals into a data stream in accordance with an embodiment of the invention;

FIG. 4 is a flow chart of a method of returning effect signals associated with a media presentation in accordance with an embodiment of the invention; and

FIG. 5 is a flow chart of a method of embedding effect signals in a transmission, in accordance with an embodiment of the invention.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well-known features may be omitted or simplified in order not to obscure the present invention. Various examples are given throughout this description. These are merely descriptions of specific embodiments of the invention. The scope of the invention is not limited to the examples given.

Unless specifically stated otherwise, as apparent from the following discussions, it is appreciated that throughout the specification, discussions utilizing terms such as “processing,” “computing,” “calculating,” “determining,” “deriving” or the like, refer to the action and/or processes of a processor, computer or computing system, or similar electronic or hardware computing device, that manipulates and/or transforms data represented as physical, such as electronic quantities within the computing system's registers and/or memories into other data similarly represented as physical quantities within the computing system's memories, registers or other such information storage, transmission or display devices.

The processes and displays presented herein are not inherently related to any particular computer, communication device or other apparatus. The desired structure for a variety of these systems will appear from the description below. In addition, embodiments of the present invention are not described with reference to any particular programming language, machine code, etc. It will be appreciated that a variety of programming languages, machine codes, etc. may be used to implement the teachings of the invention as described herein. Embodiments of the invention may be included on a medium or article such as a hard disc, CD, DVD, “disc on key”, memory stick, or other memory unit having stored thereon instruction that when executed implement an embodiment of the invention, or having files or data corresponding to effects stored thereon.

Embodiments of the invention may process media signals that are digital recordings represented by a bit stream, or analog signals, for example composite video or s-video signals. Signals on which to produce effect signals may be based on analog or digital portions of media signals.

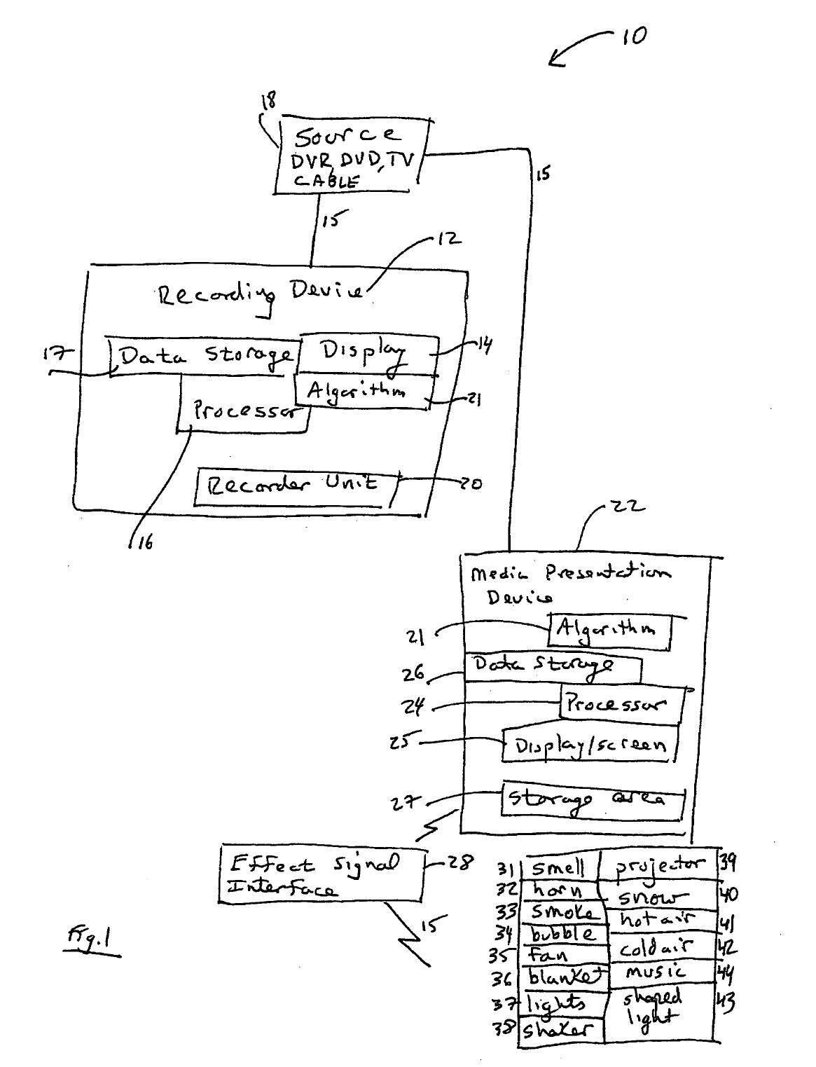

Reference is made to FIG. 1, a schematic diagram of components of a system for synchronizing effects in accordance with an exemplary embodiment of the invention. System 10 may include for example a media recording device 12 that may include one or more recording/reading unit(s) 20 of for example digital or analog media presentations, such as for example a VCR, hard disc drive, memory stick, other portable memory device reader/writer, compact disc (e.g., CD or DVD), read only memory (ROM) burner, digital tape recorder, MP3 recorder or other device or component suitable for recording or reading for example a data stream such as video or audio signals or digital effect signals that may be added to such streams. A media presentation signal or data stream may include for example, a movie that is played back by a VCR, VTR, DVD, a memory in a computer (e.g., a DVR), sent and received from a streaming media site, a broadcaster (e.g., cable or broadcast television), the output from a video game, a video game signal received by a network, etc. A presentation signal or data stream may be analog, digital, or a mix thereof. Other data streams may be used.

In some embodiments recording or reading unit 20 may include for example a read/write device such as for example a laser, disk drive head or other device suitable for reading and/or recording digital or analog data. Other recording devices may be used. Media recording device 12 may include a display 14 such as for example a screen suitable as an interface for a user or integrator of effect signals, and by which such user may for example compile a list or insert effect signals into a data stream of media such as video or audio. In some embodiments, media recording device 12 may be a PC or workstation.

Media recording device 12 may include one or more processors 16 such as for example a central processing unit that may be suited for recording and processing presentation signals, data streams and graphic displays and for executing other algorithms. Media recording device 12 may include a memory such as for example a data storage unit 17 or data storage medium. In some embodiments media recording device 12 may be linked to a source 18 of a media presentation such as for example a television antenna, DVD player, MP3 player, satellite dish, digital video recorder, cable TV, Internet, or other source or feed of media such as for example audio or video.

In some embodiments, media recording device 12 may include or may be operably linked with a media presentation device 22; such devices may be separate. For example, media recording device 12 may be used to create “effects files”, stored in a memory or digital memory (e.g., a RAM or ROM, memory stick, disk-on-key, CD, floppy disk, etc.) and media presentation device 22, which may be physically distant from media recording device 12, may be used to play back such files, when associated with the appropriate equipment.

Media presentation device 22 may be or include none or one or more display screens, projectors, speakers or other devices suitable for presenting video, audio, digital video games, or other presentation media to for example a viewer or listener. In one embodiment, media presentation device 22 may read or detect signals from the source 18 that indicate that an effect is to be triggered at a given time or period in a media presentation, or in synchronization with and reflecting or complementing some event, sound, sight or other occurrence in the presentation at the time of the effect. Such signals may be, for example, taken directly from a media stream (e.g., if effect command signals are embedded in a movie presentation) or generated from a combination of signals derived from the media stream or read from an additional effects data file that was for example previously loaded to the media presentation device 22. In embodiments where effects are generated based on information derived from the media stream, modification of the original media stream (e.g., insertion of effects commands into the media stream itself) may not be necessary.

Media presentation device 22 may include or be operably linked to a feed or source 18 of digital or analog media such as for example a radio or television antenna, DVD player, MP3 player, satellite dish, digital video recorder, cable TV, VCR or other source or feed of media such as for example audio or video, or other device for suitable reading media or data streams. In one embodiment, media presentation device 22 and effect signal generator interface 28 may be included in a “set top box”, computer game console or part thereof. For example, presentation device 22 and effect interface 28 may be divided in functionality between, e.g., a DVD player or other media player and a separate effects unit. The source 18 may output to a conventional television set and also to an effects unit. Other configurations are possible.

In some embodiments, media presentation device 22 or media recording device 12 may include or be operably linked to an effect signal generator interface 28 via wired or wireless link. Effect signal generator interface 28 may be or include one or more hardware and/or software components that may for example link it to presentation device 22 and to effects generators 31-44 via wired or wireless link. In some embodiments effect signal generator interface 28 may be, include or be operably linked with for example one or more of effects generators 31-44 such as scent generator 31 (such as may be capable of producing scents for flowers, perfumes, grass, oceans, foods etc.), a smoke machine 33, a horn 32, bell, alarm, bubble blower 34, heat source/blanket/chair 36, strobe and other light sources 37, colored lighting or light filters, fan 35, vibrator/shaker 38, projector 39, snow maker 40, hot air blower 41, cold air blower 42, shaped or laser light 43, music generator 44 or other device or generator of effects that may enhance or supplement a listening or viewing experience of a digital media presentation. In some embodiments, effects may be limited to visual effects such as for example color backgrounds on a scene, words or symbols added to a scene of the presentation. In some embodiments such effect-producing devices may be linked to a central effect signal generator interface 28 by wires or wireless links such as for example Bluetooth, power-line communication links or other wired or wireless links. In some embodiments, effect-producing devices may be combinable in modular formations so that they may be for example stacked or included in a single unit, or purchased separately and placed in varying locations in a presentation area or be operated separately or in unison to accentuate the effect. In some embodiments, an effect machine may include for example consumable refill chambers so that consumable materials may be added to the unit. For example, material for smoke machine 33 or bubble machine 34 may in some embodiments be refilled with modular refill packages, to prevent the need to pour the fluid from a canister or a container to a container in the effect machine, but rather replace the container as a whole.

In some embodiments a control system may allow a viewer to select effects desired or not desired or to let a user activate, deactivate or change the characteristics of (e.g., level, volume, etc.) an effect upon his command. For example, if an effects track calls for a scent at a certain point, but a scent device is not attached to the system or a scent effect is not desired by the viewer, a scent need not be produced. In some embodiments, communications between digital media presentation device 22, generator interface 28 and effect-producing devices may be two way so that, for example, effects-producing devices may communicate a status or presence/absence of information or a presence or absence of refill or consumable material levels to presentation device 22 or via generator interface 28.

Media presentation device 22 may include or be linked to for example a data storage 26 medium such as for example random access memory, a disc drive, memory stick, disc on key, or other memory suitable for storing for example a database, or file or set of files of values, times, image files, audio files, graphics animation files, and other effect signals. Other items may also be stored in data storage 26.

Media presentation device 22 may include a processor 24 that may be suitable for processing signals such as those in a media presentation data stream, and may include an input for analog signals such as those in a composite video signal. Processor 24 and processor 16 may also execute functions or algorithms 21 such as for example a cyclic redundancy check (CRC) algorithm, a hash algorithm, or other function that may derive or generate an identifying value from a segment or multiple segments of data in a data stream. In some embodiments, a CRC or other suitable algorithm may be performed on a non consecutive very low bandwidth portion of data extracted from a data stream or presentation signal. Processor 24 may have other capabilities. In some embodiments, such value may be stored in for example data storage 26 or data storage area 27. In some embodiments processor 24 may be connected to a display 25 such as for example a television, monitor or projector 39. Processor 24 may be connected to a remote control receiver such as for example an infra red or radio frequency receiver or Ethernet port that may facilitate control of digital media presentation device 22 via a remote control, or a communication protocol. Display 25 or projector may be used to display media and/or effects (if suitable) processed by processor 24. Other connections such as for example connections by wire are possible. Such wire connections may in some embodiments be included in for example an Ethernet or a home automation system or a video output to connect to a TV as a display unit.

In some embodiments, some or all of the components in FIG. 1 may be combined or divided into fewer or greater number of units or components. In some embodiments some or all of the components in FIG. 1 may be linked by wire or wireless connections 15. In some embodiments, media recording device 12 may not be linked to media presentation device 22, and the process of recording values and placing effects in a time line corresponding to the media timeline may be performed separately and at different times from a presentation of the media and the effects. In some embodiments a user may customize effects to accompany a media presentation. In some embodiments the media presented and fed to device 22 may be received from a broadcast such as an analog television broadcast or a digital television broadcast. In some embodiments the effects signal and timing information may be embedded in the media signal sent to device 22.

In some embodiments, media presentation device 22 may include for example a digital media player such as for example a DVD player or MP3 player, and separate unit such as for example a unit with a processor 24 to for example derive a value, search a database and signal an effect generator interface 28.

Media presentation device 22, generator interface 28 (which may be physically incorporated with presentation device 22), and effect-producing devices 31-44 may for example be linked by wires or wirelessly, for example by devices using for example a Digitally MultipleXed 512 protocol (UITT DMX 512-1990 published by the USITT), or for example a Z-Wave™ wireless protocol. Other suitable protocols or linking technologies may be used. In one embodiment commands may thus be sent in an abstracted form, rather than directly, via wires carrying actuator signals.

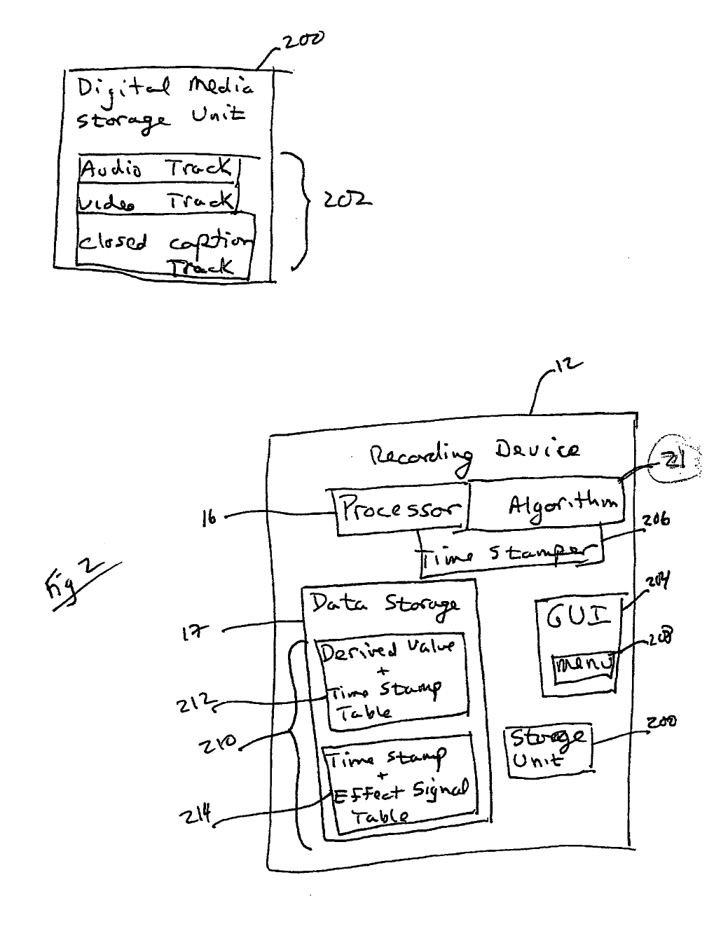

Reference is made to FIG. 2, a schematic diagram of a media storage unit and a media recording device with a data storage unit in accordance with an exemplary embodiment of the invention. A media storage unit 200 such as for example a VCR, DVD, compact disc, MP3 memory or disc drive, for the signals that may be stored on such unit 200 that may include or be segmented into one or more tracks or lines 202 that may store one or more types of signals corresponding to for example audio, video, subtitles, close caption or other signals that may make up for example the inputs of a media presentation signal stream. In some recording media, such as for example, a VCR, close caption or other signals may be stored or embedded in the signal or data stream. For example, in the National Television System Committee (NTSC) and Society of Motion Picture and Television Engineers (SMPTE) 259M, digital systems, closed captions may be encoded onto the video image line 21 in the Vertical Blanking Interval (VBI). A track or line 202 may generally be left empty on some recording media, and effect signals may be added or inserted onto such empty lines 202. In some embodiments, effect signals may be added to for example a closed caption track or lines 202. Other or additional tracks or lines 202, channels or tracks may be keyed off.

Media recording device 12 may include an interface 204 such as a screen or other display that may for example be employed by a user or content provider to record, index, program or insert effect signals, and to associate such signals with segments of a digital media data stream. In some embodiments, interface 204 may include a graphical user interface 204 such as for example a menu 208 driven software package. Menu 208 may include various functions through which a user may select, insert, modify, change or extend the effects that are to be linked with a particular segment of a media presentation.

Media recording device 12 or another component of system 10 may include a time stamper 206 that may assign or associate a time value (e.g. a time point, a time stamp, etc.) with some or all of the segments in a data stream of a digital media presentation, or with a position in the media stream or presentation, typically based on the actual time elapsed in the digital media presentation. For example, time stamper 206 may assign a time stamp or time point according to a position of one or more close caption signals that are included in a presentation. Other starting points or fixed points or references in a media presentation may be used by time stamper 206. For example, a time stamp may include minutes, seconds, and fiames with a time elapsed of a presentation. Other intervals or time methods may be used.

In operation and in some embodiments, a media storage unit 200 or another source 18 may feed or otherwise load a media presentation data stream into media recording device 12. In some embodiments, recording or loading a media presentation may not be required. Time stamper 206 may assign a time stamp or time mark to for example one or more frames or other segments in such recording. Time stamps, time points or other time data may be stored in for example a first table in the form of for example signals in for example data storage 17 or on a media storage unit 200. A processor such as for example processor 16 may use for example algorithm 21 to derive or calculate an identifying number or value from for example a designated number or pre-identified series of bits in a data segment or in a track or line 202 of the loaded recording. For example, processor 16 may derive a value such as for example a CRC value for a particular or designated portion of one or more close caption tacks or lines 202 in a recording. The derived values may be loaded into the first table, such that the derived value for a particular or designated portion of for example the closed caption lines is associated with the time stamp entry in the table that matches the time when the closed caption line appears in the recording.

The first table may for convenience be described as a ‘derived value+time stamp’ table 212 and may include for example a series of value pairs for a particular song, movie, music video clip or other digital recording, where the derived value, such as the CRC value, for one or more segments of the recording is associated with the time stamp for such segment of the recording. Other designations for such table may be used. For example, a list, table or database may be created for a movie, such list, table or database to include a list of time stamps or time point and associated CRC values that may be derived from for example close caption lines that appear in the movie, where some or each close caption line has a derived CRC value, and such CRC value has an associated time stamp or time point. The time stamps or time values associated with values derived from pre-identified portions of a data stream, such as frames, closed captioning or other signals, may be used to set a clock or timer for time elapsed for the media presentation, or indicate time stamps between which the actual time elapsed may be interpolated to create a highly accurate time elapsed value for the presentation and timing of activation of effects.

An effect arranger, programmer, content provider or other user may use system 10 to create for example a second table such as an ‘effect signals+time point’ table 214. The inserted effect signals may be stored in table 214 and may be associated in such table with the time stamp or time point for the particular segment of the media presentation data stream where the effect is to be generated. A series of value pairs may be created in the second table, where such pairs include effect signals and identifiers associated with the time stamp for the segment of the media presentation where the effect is to be generated. The value pairs may include, for example, effect properties parameters identifiers such as for example volume, intensity, color, duration. For example, a user creating a set of effects may select or set a parameter or property of an effect, for example, the duration, intensity, loudness, color, scent, frequency, movement, activation, deactivation, or any other applicable property.

Database 210 that may include for example table 212 and table 214 may be stored in for example data storage 17, which may be for example a CD, CD-ROM, RAM (e.g., internal RAM), portable memory such as “memory stick” or “disk on key”, etc. and may be ported to for example data storage 17 or 26 that may store files or databases relating to more than one media presentation, e.g., more than one movie.

In an embodiment, media presentation device 22 may be connected to a playback device or a receiving device (e.g., television antenna, set-top cable box or a video game console), which may produce or deliver a media presentation. Media presentation device 22 may analyze the signal of the presentation, or a signal associated with the presentation, and based on a portion of the signal, generate effects, or generate commands to cause effects without the need for the list of effects to be stored beforehand on data storage 26. Also media presentation device 22 may derive values from a portion of the media presentation, compare them to a stored file of values, and from this comparison detect the identity of the data file corresponding to the presentation signal and generate a time clock used to generate effects.

Embodiments of the invention may include recognition of a signal, for example a digital stream of a movie presentation, based on calculating a sequence of values composed of one or more values and searching for a unique sequence of values in one or more tables or collections of values, returning a name or identifier describing the signal for example the movie name associated with the table or collection of values containing the searched sequence.

During a media presentation of a recording, such as for example when playing a song, video presentation or movie, one or more files or tables of database 210 that may include derived values, time stamps and effect signals along with their respective associations, may be fed into or made available to a processor 24 of for example media presentation device 22. Processor 24 may execute algorithm 21 on one or more segments of the data stream of the movie, song or media presentation being played and may derive one or more values from the designated lines of the song or movie. For example, algorithm 21 may be executed on close caption signals in for example a data stream of a movie. Processor 24 may search for example the derived value+time stamp table 212 of one or more database 210 files for one or a series of values that is equal to the value or values that processor 24 derived from the segment of the movie, song or digital presentation being played. In some embodiments, processor 24 may search database 210 files containing one or more media presentations such as for example one or more movies to find a series of stored values that matches the series of derived values. Finding the series of stored values that matches the derived values may indicate to the system 10 which media presentation is being presented on the system 10 and the time elapsed in the presentation. The derived value in table 212 may be found along with its associated time stamp or time point entry. In some embodiments, using a derived value based on a portion of a media presentation (for example, a CRC of a closed caption signal), allows the system to not store any part of the actual digital media presentation or media stream separate from a copy of the presentation (e.g., a DVD in the case that the DVD is part of system 10). In some embodiments, the presentation signal or data stream may come from source 18 which may be separate from the rest of a system 10.

Upon determining the time stamp entry for the segment of the media presentation and interpolating the timing of the presentation, processor 24 or another processor may look up the time stamp entry on the table 214, and determine the effect signal that is associated with the particular time of the presentation. Processor 24 or another processor or component may trigger the effect that is associated with a time point when the interpolated time signal is sufficiently equal to the required specified effect trigger time.

In some embodiments, the association of a derived value with a corresponding time stamp and an effect signal with a corresponding trigger time stamp or time point, allows the effect signal to be synchronized with a particular segment or time position of a presentation, and such synchronization may be retained regardless of the starting point of the running of the data stream. For example, if a viewer starts to watch a movie at a scene somewhere in the middle of the movie or if a viewer advances, rewinds or skips a scene, one or more CRC values of for example a close caption line 202 of such scene may be generated from the segment being presented. The CRC values may be found in a table such as the derived value+time stamp or time point table 212 to determine the new time stamp value for the segment being presented. The determined time may be interpolated between stamp and used to look up on table 214, and trigger the effect associated with such time stamp or time point that may signal for example the effect signal generator interface 28 to activate an effect at the time indicated on the associated time stamp entry such that the generation of the effect is synchronized with the scene in the presentation. Updates and synchronization of the interpolated time based on the derived CRC values and their corresponding time stamps pairs may be performed occasionally or periodically in the course of the presentation, to maintain accuracy. In some embodiments, a large deviation between the interpolated time and the looked up time stamps may indicate a non continuous media presentation, such as may be caused for example by a user pausing a presentation or fast forwarding or changing channels in a cable box. In some embodiments, this may cause the system 10 to initiate a stop command to effects generators via interface 28, and may trigger processor 24 to start looking for a new matching data set and location to match the new media signal or new media playback or broadcast position. For example, if the continuity of the presentation stream or media stream is altered, for example by pausing, rewinding, etc., the clock may be re-synchronized based on, for example derived values. In a typical embodiment, the clock is continually or repeatedly synchronized based on, for example, the occurrence of certain values such as closed caption signals. For example, whenever a closed caption signal occurs, the clock may be re-synchronized; in this way a user's alteration of the flow of the media presentation (e.g., stopping, rewinding) may not affect the ultimate clock setting.

An internal clock within device 22 may correspond to the actual elapsed time of the media presentation being played. For example, based on finding a certain number of CRC matches between the media presentation being played and the database 210, the time stamp or time point values in database 210 may be combined with a real time clock to produce the interpolated time elapsed timestamp or clock corresponding to the media presentation time position.

In some embodiments, an effect generated based on a media presentation may include an advance time for initiating effect, typically based on the time it takes between when an effect is initiated and when an effect is expected to be sensed by a viewer; for example the time it takes a fan or bubble machine to come up to speed, or the time it takes a scent to travel to a viewer. Effects commands may be adjusted (typically advanced) based on the advance time assigned to the affect If, for example, the media presentation is a broadcast or a media stream, the effect command or activation may be placed in the media stream ahead of the time the effect is to take place. If the media presentation is pre-recorded, there may be an advance time adjustment included with the effect command in the stream, or the effect command may be pre-adjusted, when the effect file is created, and moved ahead in the timing of the stream in advance.

In some embodiments, as a result for example of a possible time lag between a start of an effect and the time when the effect is perceived by a viewer, or for other reasons, a signal for an effect may be generated before reaching the scene or event in a digital media presentation where such effect is called for, so that the impact of the effect on a viewer coincides with the event seen or heard by the viewer. Such a lead time or delay may in some embodiments be programmed into the effect track by unit 10 or by the media presentation device 22 by for example a menu 208 of an effect setup program. Such a delay or lead time may be set as a default to the activation of a particular effect signal so that the particular effect signal may be triggered at a designated period before the effect is to be felt. Particular effects may have particular lead time defaults, and such lead times may be adjustable by a user. The length of the delay between the time when an activation signal is sent to an effect generator interface 28, and the time when the desired effect is to be perceived by the viewer may differ among the various effect devices 31-44 due to for example interface technology differences and human perception differences. For example a light may be perceived by the user much faster than scent, so the scent generator may be activated well in advance of the time when the scent is to be perceived by the user, while a light may be activated at the desired perception time. The pre-activation may also be set to compensate for other factors such as for example room size differences since effects may have slow and different propagation time in the room. Similarly, wind may take longer to travel and be felt by a user later in a larger room than in a smaller room. The adjustment of such delay may be set to account for an assumed standard installation, and may be adjusted to reflect particular factors in an installation when for example the effects file is recognized and loaded. In some embodiments, one version of the effect track data may be distributed to users, and a user's system may customize the timing of effect triggers to match the specific characteristics of the user's viewing area to effectively create a consistent experience for all viewers that accounts for their different viewing environments.

In some embodiments an effect signal may activate or deactivate an effect device, and a different signal may vary the intensity of the effect produced by the device or may vary other properties of the effect. For example, a signal stored in table 214 may activate a horn 32 device. The intensity of the sound produced by the horn 32 device may be varied with the level of sound generated in the scene of for example a movie having a horn, so that for example the horn 32 device makes a louder sound as the horn sound of an oncoming train becomes louder in a movie scene. In another example, a strobe light may be activated so that its flashes are triggered by a music beat. Other properties of an effect may also be varied such as duration, intensity, color, scent.

In some embodiments a signal for a first effect may be activated or deactivated independently of a signal for a second effect, such that two or more effect generators may be activated independently. In some embodiments, for example, an effect may be or include turning on or off a particular track of for example audio or video, e.g. video stored along with database 210 in storage device 26, or passed through device 44 such as may be done in a Karaoke presentation where a singer's voice may be turned off and the singer voice may be mixed over the music, where a different sound track may be overlaid or mixed in by device 44. In some embodiments, an explanation track may be added for example to classical music to explain appreciation points of the music.

In some embodiments, processor 24 may derive values from more than one data segment as part of the procedure of identifying the portion of the media presentation being presented.

In some embodiments, a particular collection of data points may be present only intermittently in a media recording. For example, a close caption line may be present only during scenes of a movie with dialogue, and not during scenes that show for example cannon fire where an effect is to be inserted. An ongoing, time elapsed clock or timer may be maintained by device 22. The clock or timer may be set based on suitable signals from the media recording. For example, a closed caption signal may be used to create a derived signal, which may be used to generate a time stamp corresponding to that derived signal. The resulting time stamp may be used to set the time elapsed clock or timer. For example, if a closed caption signal is output at 33:14:12 (33 minutes, 14 second, twelfth frame) of a recording, a CRC matching this closed caption signal may exist, in a file, paired with this time stamp, and a timer may be set to 33:14:12 and advanced as appropriate by the system 10. A processor 24 may interpolate the time (or advance the time elapsed clock or timer) that may elapse between a close caption signal for which a CRC or other derived value may be generated, and the time at which an effect is to be felt or an effect signal is to be generated, so that the effect coincides with the event being presented on for example a viewer's screen. The interpolation may be adjusted if the deviation between the stored time stamp and the interpolated time is sufficiently small, or an indication may be given to indicate synchronization loss in case the deviation is large.

In some embodiments, a track of effect signals, may for example be purchased or downloaded for a particular video presentation, movie or song, and such track may associate values such as time stamps or CRC values (directly or indirectly through for example a time stamp) with for example the effects to be rendered during such movie, song or other media presentation.

In some embodiments, effect signals may be created, inserted or manipulated by way of for example an authoring tool that may employ standardized formats such as for example a mark-up language or extendable command language such as HTML, XML or other formats. In some embodiments, the authoring tool may be stored in for example data storage 17 as is shown in FIG. 1 or elsewhere in for example a media recording device 12. In some embodiments, the authoring tool may be suitable for generating, storing and triggering effect signals, for example independent of the media presentation. For example, embodiments of the invention may enable a user or other effect generator to insert effect signals to a media presentation that was recorded earlier, or exist on a DVD, and modify the effect track that was created earlier, and generate a new effects track.

In an embodiment of the present invention, a media presentation (whether broadcast, streamed, generated by a video game (console, internet based, or other) or simulation device, or played back from a recording by a user) may include, or may be augmented to include, effects data, or data from which effects commands may be generated. An effects signal may be embedded in a digital output or in the analog output, for example an output from a video game, or a broadcast signal, or another signal for example as part of the closed caption data. The signal may be processed, and effects triggered based on the signal. The signal may be processed upon receipt of for example the digital or analog transmission at a location that is remote from the broadcast.

In some embodiments, a signal that is for example broadcast, streamed, or produced by a video game may include a media signal (e.g., content, such as images, sounds, etc.) and in addition an effect signal. A receiving system may receive the signal and at the same time display the media portion and trigger effects based on the effect signal.

In some embodiments, for example, an XML or other effect generation signal may be embedded between for example close caption lines or in another place within a media stream or presentation, so that direct activation of devices or effects may be accomplished without the need for storing effect, or recoding the media presentation data stream in the user's system, and without generating time stamps. Effect commands may be embedded in the media presentation data stream itself, and for example, media presentation device 22 may be suitable for reading and executing commands and effect signals that are programmed directly into the data stream. For example, effect signals may be inserted into a closed caption track or line 202 of for example a television broadcast, and such effect signals may be read and processed by for example media presentation device 22 which may send or relay such signals to interface 28 to create effects at the location of the viewer or listener. Similarly, media presentation device 22 may be connected to or included in for example a video game console which may read or generate effect signals, embed the effect signals in digital data that is transmitted to a media presentation device 22 to trigger effects.

In some embodiment an Internet broadcast to for example a personal computer or a digital satellite or cable TV broadcast to a digital satellite or cable box may trigger special effects by sending commands to the media presentation device 22 via for example a serial port or an Ethernet link between device 22 and the personal computer or the Digital Satellite or Cable Box.

Such embedding of effect commands in a digital presentation may be used for example in fast-changing content such as commercials or video game scenes, where for example the scene that accompanies the effect is shown for example for a brief period and in a relatively unpredictable order. For example, in some embodiments, one or more effect signals may be embedded in a scene or ‘room’ of an electronic video game. When a player enters a room of the game, the effect signal may be generated or one of a random or varying effect signals may be generated to accompany the action in the room. In some embodiments the effect signal may be delivered by an Ethernet port associated with the game. In some embodiments, an effect signal may be included in a media presentation or a transmission of video or audio, such as for example a Video Cassette or digital media presentation such as music CD or a music or video download, a DVD or other electronic file(s) that includes a digital media presentation. In some embodiments, a file with digital effect signals that may accompany a media representation may be purchased or downloaded as for example an add-on or upgrade to a music or video recording.

In some embodiments an effect signal may be delivered by a broadcaster of for example a television show, commercial, music program or other broadcast. The effect signals may be delivered in for example real time, in coordination with the timing of the scene or event being broadcast, or may be delivered in for example, a batch at the start or at various intervals in a broadcast or in the course of a day or other period. In some embodiments, the effect signals may be delivered as part of for example the closed caption signals that may be delivered along with the broadcast signals or elsewhere in the delivered signals. In some embodiments, real time delivery of effect signals may be delivered in advance of the desired time for the perception of the effect by a viewer or listener, to allow for a possible delay between the timing of the signal to activate the effect and the time of the perception of the effect by a user in some embodiments, system 10 may not record a media presentation data stream, but rather the data stream received may include the effect signals. In some embodiments, only a particular track or line 202, such as for example a close caption line 202 and its associated time stamps or time points that may include effect signals, of a data stream may be recorded by system 10. In some embodiments, effect signals may be inserted into a track or line 202 in a process that may be similar to the process for example inserting close caption signals, and such effect signals may not impair or alter the media presentation data stream that is transmitted. In some embodiments, the timing of inserted effect signals may be interpolated based on time stamps of for example close caption signals to derive a precise synchronization of the effect signal with the media presentation.

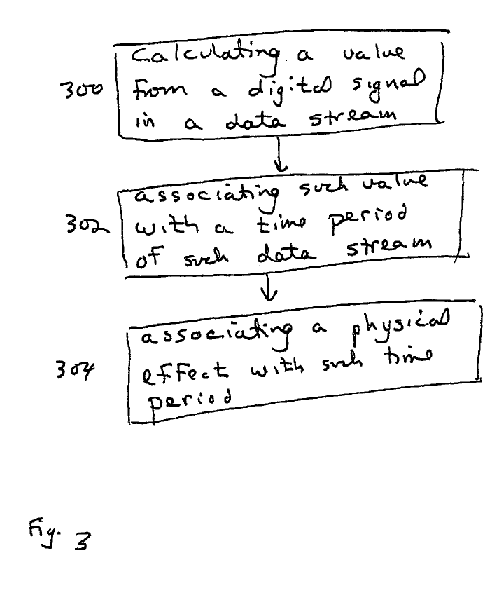

Reference is made to FIG. 3, a flow chart of a method of inserting effect signals into a data stream in accordance with an embodiment of the invention. In block 300, a value may be calculated from for example a segment of a data stream. In some embodiments such value may be calculated by a known function such as for example a CRC function. In some embodiments the segment of a data stream may be for example a group of bits in a line of for example close caption data, at for example the beginning of a video frame or the VBI interval. Other defined segments may be used as a sample segment upon which to run a function or algorithm to derive a value.

In some embodiments, signals, such as for example closed caption signals, from which derived values may be generated may be spread over many frames of for example video frames, such that the derived value is based on one or more distributed segments of data rather than on a continuous segment of data, as would be the case if the value were derived from for example a sound track or scene or a picture that may appear in a digital presentation.

In block 302, the calculated value may be associated with a time stamp, time point or other indication of an interval from a given reference point of the data stream. For example a reference point of a time stamp may be the beginning of a video stream. Other reference points may be used. In some embodiments, the value and its associated time mark may be stored on a database in a storage medium. In some embodiments the time stamp for the digital presentation may be added in for example at the preparation stage of the presentation. For example, a time stamp may be added when a presentation is read into a computer or digital device.

In block 304, a signal to activate an effect, such as for example a physical effect, may be associated for example with the time stamp or time point that was assigned to the effect, and the effect may be activated when the time stamp associated with the derived clock is virtually the same as the time stamp associated with the effect. The effect may augment an event or action that is presented in for example the video or audio in the data segment.

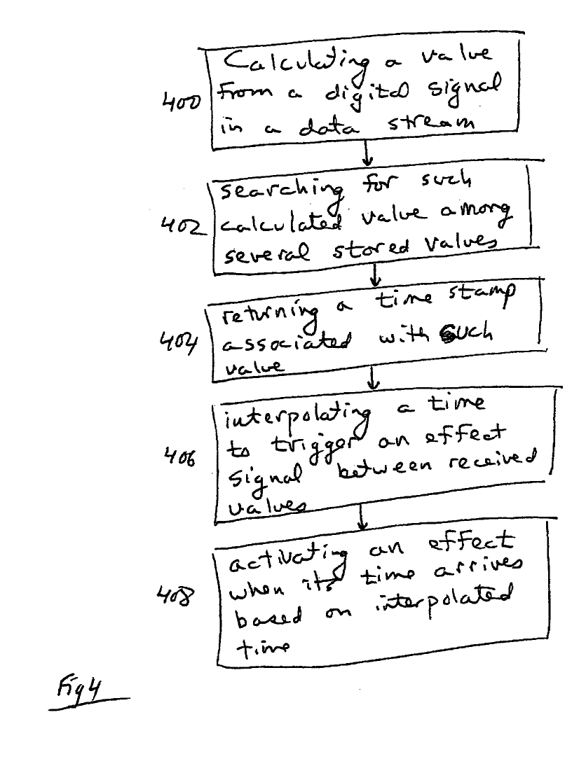

Reference is made to FIG. 4, a flow chart of a method of returning effect signals associated with a time stamp in accordance with an embodiment of the invention.

In block 400, a value may be calculated from a segment of a data stream, for example a digital signal within a presentation stream or data signal. In some embodiments, the value may be calculated by a function such as a CRC or hash function as it may be applied to a series of bits or other data signals in a particular segment of a presentation stream. Such value may in some embodiments be a numeric value. In some embodiments the segment may be a part of for example a close caption signal or another line of for example a DVD data stream.

In some embodiments, the value may be derived from a segment of a data stream, where the data stream itself is not entirely digital. For example, a value may be derived from a digital portion of an analog signal. Further, a value may be derived from an analog portion of a signal.

In some embodiments, an effect command may be extracted directly from a media stream or presentation; for example a broadcast or a video game output may include effect commands. In such a case no derivation (e.g., CRC) may need to be performed on a value within the media stream.

In block 402, a database or collection of several values may be searched to find the value that was calculated in block 400. In some embodiments, the values stored in for example a database may be associated with a time mark or time stamp that reflects for example a chronology or order of the presentation of the data segment in a media presentation such as a movie or song, relative to a reference point or time, such as a beginning of the movie or song. In some embodiments several values may be calculated and searched for in a database. Identifying more than one, or a sequence of values and a sequence of associated time periods, and determining that such time periods are consecutive or chronologically ordered, may reduce the possibility of identification of a value with an incorrect time period in a media presentation. Identifying a sequence of values may also allow a system to detect which digital presentation is being viewed or listened to at the particular time.

In block 404, the time stamp associated with the value that was searched for may be returned to for example a processor. A time stamp may be associated with a signal for the generation of an effect such as a physical effect at a particular portion of a media presentation. An elapsed time clock may thus be generated and maintained.

In block 406, a processor may interpolate the time that an effect signal is to be generated between the time for example of such first close caption signal and a second closed caption signal. The interpolation may produce a more precise timeframe for triggering of an effect signal.

In block 408, a signal to generate a physical effect that may be associated with a time stamp generated by an elapsed time clock may be returned for example to a processor or to a generator of such physical effect. In some embodiments, a signal to generate an effect may be issued at a period that precedes the time that the effect is to be sensed by a viewer or listener. The interval between the generation of the signal and the time the effect is to be perceived by a user may approximate the time necessary for the effect to be produced and detected. An effects file or signal may be structured to issue a signal to execute an effect a set time period before a user is to perceive the effect. In another embodiment, an effects generator or effects decoder may itself determine, based on the effect to be produced, a delay or a time by which the effect's activation should be advanced. For example, device 22 may, when it activates smoke effects, always advance the activation time by X seconds.

The timing of the generation of the physical effect may be based on the time stamp returned in block 404. Typically, in most cases (but not all) the effect signal is to be generated at a time stamp generated in block 404 not corresponding exactly with the time stamp associated with the value obtained at block 402. Thus an effect may be based on a time interpolated by a timer or clock generated by and synchronized with time stamps generated in block 404. In some embodiments, it may be necessary to account, by for example interpolation, for effect signals that are to be generated after the time of for example a first closed caption signal, and before the time of for example a next closest closed caption signal.

In some embodiments, the length or other factors of a delay in the generation of an effect based on an effect signal may be modified by for example interface 28 or processor 24 based on factors such as the size of a room or area wherein a user may be viewing a presentation. For example, a signal to produce an effect at a particular moment in a media presentation may be modified by for example interface 28 or another component of presentation device 22 to accelerate the execution of the effect based on its setup. For example a room delay may be 2 seconds, a control delay may be 50 milliseconds, and a user's sensory delay may be 100 milliseconds. Other numbers may be used. An effect trigger point specified calling for a specific effect timing, may be sent ahead of time in an amount defined as an assumed maximum delay possible for that effect, the effect trigger command may include the assumed maximum delay value and the required trigger point which may be on arrival of the command or current time. The effect trigger may be modified for example as follows: Activation time=current time+(assumed maximum delay)−(room delay time+sensory delay time+control delay time). Current time may be replaced by a different time value referring to the required trigger timing. Other factors may be used. In some embodiments, the inclusion of delay or acceleration times in the synchronization of the effect generation may be independent of the media presentation. In some embodiments such delays may be controlled by set up details adjustable by the viewer.

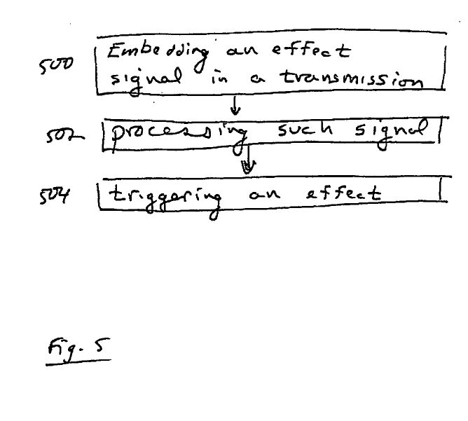

Reference is made to FIG. 5, a flow chart of a method of embedding effect signals in a digital transmission, in accordance with an embodiment of the invention. In block 500, an effect signal may be embedded in a digital or analog transmission. The transmission may for example be included in a broadcast of for example radio, television, cable television or for example Internet or other network based entertainment.

In block 502, when received by a receiving device (e.g., a personal computer, a set-top-box, a device connected to a decoder or receiver receiving television signals, etc.) the embedded signal may be processed to for example convert the signal into a signal that triggers an effect device to create an effect. For example, a processor may in some embodiments be or be connected to a set-top box that may process an effect signal received over television channels or cable television or Internet. The processing may take place at for example a location remote from the broadcaster such as the home or viewing place of the viewer. Effects triggers can also be transmitted from the broadcaster over the internet completely outside of the presentation signal.

In block 504, the processed signal may be transmitted to an effect device such as for example, a strobe light, a wind machine, a vibrator or other effect creating device; for example a device shown in FIG. 1.

Other operations or series of operations may be used.

It will be appreciated by persons skilled in the art that embodiments of the invention are not limited by what has been particularly shown and described hereinabove. For example, the derivation of values and the association of such values with time stamps and signals may be used in fields other than digital video and audio presentations. The scope of at least one embodiment of the invention is defined by the claims below.

1. A method comprising:
calculating a value from a presentation signal;
associating said value with a time point of said presentation; and
associating an effect with a time point of said presentation signal.

2. The method as in claim 1, wherein said calculating a value from a presentation signal comprises calculating a cyclic redundancy check from a data segment of the presentation signal.

3. The method as in claim 1, wherein said calculating a value from a presentation signal comprises calculating a cyclic redundancy check from closed caption data where the presentation signal contains closed caption data.

4. The method as in claim 1, wherein said associating said value with a time point comprises associating said value with a time point of the presentation.

5. The method as in claim 1, comprising storing said value and said associated time point in a data storage medium.

6. The method as in claim 1, comprising selecting said effect to reflect an event presented in said presentation signal during said time point.

7. The method as in claim 1, comprising selecting a property of said effect from the group comprising duration, intensity, color, scent, frequency, movement, activation, deactivation.

8. The method as in claim 1, comprising referencing said time point from a fixed point in said presentation.

9. The method as in claim 1, comprising selecting said effect from a menu of physical effects.

10. The method as in claim 1, comprising causing said effect to be executed according to said time point.

11. The method as in claim 1, comprising generating bubbles.

12. The method as in claim 1, comprising generating a scent.

13. The method as in claim 1, comprising including an effect signal in a mark up language in said presentation signal.

14. The method as in claim 1, comprising disabling an effect upon a user command.

15. The method as in claim 1, wherein said calculating a value from a presentation signal comprises calculating a cyclic redundancy check algorithm from a data segment of the presentation signal.

16. The method of claim 1, comprising generating an advance time to adjust the time the effect is generated.

17. A method comprising:
calculating a value from a signal in a presentation stream;
searching for said value in a set of a plurality of said values;
returning a time stamp associated with said value;
synchronizing a clock to said time stamp; and
returning an effect control signal associated with a time point corresponding to said clock.

18. The method as in claim 17, wherein said calculating a value from a signal in a presentation stream comprises calculating a cyclic redundancy check from a data segment of a video stream.

19. The method as in claim 17, wherein said calculating a value from a signal in a presentation stream, comprises calculating a cyclic redundancy check from a line of close caption.

20. The method as in claim 17, wherein searching for said value comprises searching for a sequence of said values in said plurality of said values stored in a table of a database.

21. The method as in claim 17, comprising searching for said time stamp associated with said value, said time stamp reflecting an interval from a fixed point in said data stream.

22. The method as in claim 17, comprising issuing a signal to control an effect.

23. The method as in claim 17, comprising issuing a signal to control an effect a set time period before a user is to perceive said effect.

24. The method as in claim 17, comprising generating a light effect.

25. The method as in claim 17, comprising generating a shaking effect.

26. The method as in claim 17, comprising disabling an effect based on a user command.

27. The method as in claim 17, comprising, if the continuity of the presentation stream is altered, re-synchronizing the clock.

28. The method as in claim 17, comprising repeatedly synchronizing the clock.

29. The method as in claim 17, wherein a plurality of effect control signals are generated, each corresponding to a different effect.

30. A device comprising:
a digital memory for storing:
a plurality of values calculated from signals in a presentation signal stream, said plurality of values associated with a time interval of said signal stream; and
a plurality of effect control signals, at least one of said effect control signals associated with at least one of said time intervals.

31. The device as in claim 30, said device comprising a processor to derive values through an algorithm applied to pre-identified bits in said signal stream.

32. The device as in claim 30, said device comprising a generator of effects corresponding to said effect control signals.

33. A method comprising:
processing a signal including a media signal and an effect signal; and
triggering an effect based on the effect signal.

34. The method as in claim 33, wherein said media signal is a broadcasted transmission

35. The method as in claim 33, wherein said media signal is a broadcasted analog transmission.

36. The method as in claim 33, wherein said media signal and said effect signal are broadcasted separately from one another.

37. The method as in claim 33, comprising processing said signal upon receipt of said digital transmission at a location that is remote from a location of a broadcast of said signal.

38. The method as in claim 33, wherein said signal is an output from a video game.

39. The method as in claim 33, wherein said effect signal includes at least a mark up language.

40. The method as in claim 33, comprising activating an effect in response to a user command.

41. The method as in claim 33, comprising triggering said effect signal from a DVD player.

42. The method as in claim 33, comprising synchronizing an effect with an output of a digital media presentation device.

43. A system comprising:
a processor to calculate a value from a presentation signal;
said processor to associate said value with a time point of said presentation; and
said processor to associate an effect with a time point on said presentation.

44. The system as in claim 43, said processor to calculate a cyclic redundancy check from a closed caption segment in the presentation signal.

45. The system as in claim 43, comprising a memory to store said value and said associated time point.

46. The system as in claim 43, comprising an effect producing device.

47. An apparatus comprising a processor to:
calculate a value from a signal in a presentation stream;
search for said value in a set of a plurality of said values;
return a time stamp associated with said value;
synchronize a clock to said time stamp; and
return an effect control signal associated with a time point corresponding to said clock.

48. The apparatus as in claim 47, said processor to calculate a cyclic redundancy check from a closed caption segment in the presentation signal.

49. The apparatus as in claim 47, comprising an effect producing device.

50. A method for producing an effect from a media presentation comprising:
accepting a media presentation:
determining an effect command based on a portion of the media presentation:
determining an advance time for initiating the effect; and
issuing a command to start the effect at the time the effect is to be sensed, adjusted by the advance time.

51. The method of claim 50, wherein determining the effect command comprises extracting an effect command from a media stream.

52. The method of claim 50, wherein determining the effect command comprises deriving a valued from a portion of media stream.

53. The method as in claim 50, wherein said deriving a value comprises calculating a cyclic redundancy check.
